(19) United States
(12) Patent Application Publication
(10) Pub. No.: US 2010/0004020 A1
(43) Pub. Date: Jan. 7, 2010

(54) MOBILE TERMINAL AND COMPOSITE PHOTOGRAPHING METHOD USING MULTIPLE MOBILE TERMINALS

(75) Inventors: Yu Seok HYUN, Gumi-si (KR); Young Hae KIM, Yongin-si (KR); Suk Woo CHAE, Daegu Metropolitan City (KR); Won Kyung SEONG, Gumi-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/496,149

(22) Filed: Jul. 1, 2009

(30) Foreign Application Priority Data
Jul. 2, 2008 (KR) 10-2008-0063874

(51) Int. Cl. H04M 1/00; H04N 5/225

(52) U.S. Cl. 455/552.1; 348/207.1; 455/556.1; 348/E05.024

(57) ABSTRACT

A mobile terminal and composite photographing method using multiple mobile terminals are provided. The composite photographing method uses multiple mobile terminals. A master mobile terminal composes an incomplete composite photograph, generates a participant list of slave mobile terminals, and sends the incomplete composite photograph and participant list to a first slave mobile terminal in the participant list. The first slave mobile terminal receives the incomplete composite photograph and participant list, further composes the received composite photograph, determines whether the composed composite photograph is complete, sends, when the composed composite photograph is incomplete, the composed composite photograph to a second slave mobile terminal in the participant list, and sends, when the composed composite photograph is complete, the composed composite photograph to all mobile terminals having participated in composite photographing. Hence, several users at distinct locations can jointly produce a composite photograph.

### PRIORITY

This application claims the benefit under 35 U.S.C. § 119(a) of a Korean patent application filed in the Korean Intellectual Property Office on Jul. 2, 2008 and assigned Serial No. 10-2008-0063874, the entire disclosure of which is hereby incorporated by reference.

### BACKGROUND OF THE INVENTION

1. Field of the Invention

The present invention relates to a mobile terminal. More particularly, the present invention relates to a mobile terminal and composite photographing method using multiple mobile terminals wherein multiple mobile terminals at distinct locations can jointly produce a composite photograph.

2. Description of the Related Art

With electronic components becoming smaller and lighter, modern mobile terminals are becoming increasingly miniaturized. In addition to basic call-handling functions, to satisfy diverse user needs, commercially available mobile terminals have various advanced features including camera-related functions.

A camera-equipped mobile terminal can provide various shot modes including still shot, continuous shot, composite shot, night shot, self-shot, and video shot. More particularly in a composite shot, several pictures are taken and combined into a single composite photograph. Here, multiple pictures are taken by the same mobile terminal. That is, a single mobile terminal can be used to produce a composite photograph. To produce a composite photograph composed of pictures of several persons, these persons may have to be present at the same place and time.

In composite shot mode, a multi-photo framing feature can be used to produce a photograph from multiple separately taken pictures. To use the multi-photo framing feature, these pictures have to be taken by the same mobile terminal, and, if the pictures are related to persons, the persons may have to be present at the same place and time.

### SUMMARY OF THE INVENTION

An aspect of the present invention is to address the above-mentioned problems and/or disadvantages and to provide at least the advantages described blow. Accordingly, an aspect of the present invention is to provide a mobile terminal and a composite photographing method that enable multiple mobile terminals to jointly produce a composite photograph.

Another aspect of the present invention is to provide a mobile terminal and a composite photographing method that reduce communication costs by utilizing short-range wireless communication to transmit a picture for composite photography.

In accordance with an aspect of the present invention, a composite photographing method using multiple mobile terminals is provided. The method includes composing, by a master mobile terminal, an incomplete composite photograph, generating, by the master mobile terminal, a participant list of slave mobile terminals, sending, by the master mobile terminal, the incomplete composite photograph and participant list to a first slave mobile terminal in the participant list, receiving, by the first slave mobile terminal, the incomplete composite photograph and participant list, further composing, by the first slave mobile terminal, the received composite photograph, determining, by the first slave mobile terminal, whether the composed composite photograph is complete, sending, by the first slave mobile terminal, when the composed composite photograph is incomplete, the composed composite photograph to a second slave mobile terminal in the participant list, and sending, when the composed composite photograph is complete, by the first slave mobile terminal, the composed composite photograph to all mobile terminals having participated in composite photographing.

In accordance with another aspect of the present invention, a composite photographing method using multiple mobile terminals is provided. The method includes composing, by a master mobile terminal, an incomplete composite photograph, generating, by the master mobile terminal, a participant list of one or more slave mobile terminals, setting, by the master mobile terminal, photo-section information for the slave mobile terminals, sending, by the master mobile terminal, the incomplete composite photograph and photo-section information to slave mobile terminals in the participant list, receiving, by each of the slave mobile terminals, the incomplete composite photograph and photo-section information, further composing, by each of the slave mobile terminals, the received composite photograph utilizing the photo-section information, sending, by each of the slave mobile terminals, the composed composite photograph to the master mobile terminal, and combining, by the master mobile terminal, the incomplete composite photographs received from the slave mobile terminals together into a complete composite photograph.

In accordance with yet another aspect of the present invention, a mobile terminal is provided. The terminal includes an input unit for composing a composite photograph and for generating a participant list, a communication unit for transmitting a composite photograph and the participant list, and a control unit for sending a composed incomplete composite photograph and the participant list to a first mobile terminal in the participant list, for further composing, upon reception of an incomplete composite photograph, the received composite photograph, for sending, when the composed composite photograph is incomplete, the composed composite photograph to a second mobile terminal in the participant list, and for sending, when the composed composite photograph is complete, the composed composite photograph to all mobile terminals having participated in composite photographing.

In accordance with still another aspect of the present invention, a mobile terminal is provided. The terminal includes an input unit for composing a composite photograph, for generating a participant list, and for setting photo-section information assigning photo-sections of a composite photograph to different mobile terminals in the participant list, a communication unit for transmitting a composite photograph and the photo-section information, and a control unit for sending an incomplete composite photograph and the photo-section information to one or more mobile terminals in the participant list, for further composing, upon reception of an incomplete composite photograph from a first mobile terminal, the received composite photograph, for sending the composed composite photograph to the first mobile terminal, and for combining, upon reception of incomplete composite photographs matching with the incomplete composite photograph having been sent, the received incomplete composite photographs into a complete composite photograph.

In a feature of exemplary embodiments of the present invention, several users at distinct locations can jointly produce a composite photograph, thereby enhancing user convenience. For example, when family members living at distinct locations desire to take a family photograph, a first member carrying a mobile terminal may select a multi-photo frame, take a facial image, insert the facial image in a photo-section of the multi-photo frame, and may send the multi-photo frame to a second member carrying a mobile terminal. Then, the second member may take a facial image, insert the facial image in another photo-section of the multi-photo frame, and may send the multi-photo frame to a third member carrying a mobile terminal. This process can be continued until a final family photograph is produced.

In addition, short-range wireless communication such as Bluetooth and the like can be used to transmit component images of a composite photograph, thereby reducing communication costs.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates communication between mobile terminals for composite photographing according to an exemplary embodiment of the present invention.

FIG. 2 is a block diagram illustrating a mobile terminal capable of producing a composite photograph according to an exemplary embodiment of the present invention;

FIG. 3 is a sequence diagram of a first composite photographing method using mobile terminals based on Radio Frequency (RF) communication according to an exemplary embodiment of the present invention;

FIGS. 4A to 4D are screen representations illustrating steps in the first composite photographing method according to an exemplary embodiment of the present invention;

FIG. 5 is a flowchart illustrating the first composite photographing method based on RF communication according to an exemplary embodiment of the present invention;

FIG. 6 is a sequence diagram of the first composite photographing method based on short-range wireless communication according to an exemplary embodiment of the present invention;

FIG. 7 is a sequence diagram of a second composite photographing method using mobile terminals based on RF communication according to an exemplary embodiment of the present invention;

FIGS. 8A to 8D are screen representations illustrating steps in the second composite photographing method according to an exemplary embodiment of the present invention;

FIGS. 9A and 9B illustrate component images transmitted during execution of the second composite photographing method according to an exemplary embodiment of the present invention;

FIG. 10 is a flowchart illustrating the second composite photographing method based on RF communication according to an exemplary embodiment of the present invention; and

FIG. 11 is a sequence diagram of the second composite photographing method based on short-range wireless communication according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the purpose of description, a mobile terminal is used as an example in exemplary embodiments of the present invention, however the present invention is not limited thereto. The mobile terminal of exemplary embodiments of the present invention is a terminal for user convenience, and may be any information and communication appliance or multimedia appliance, such as a mobile terminal, mobile phone, wired/wireless phone, Portable Multimedia Player (PMP), Personal Digital Assistant (PDA), smart phone, and MP3 player. The mobile terminal may include one or both of a radio frequency module and short-range communication module. While a Bluetooth module is described herein as the short-range communication module as an example, any other short-range communication module may be utilized.

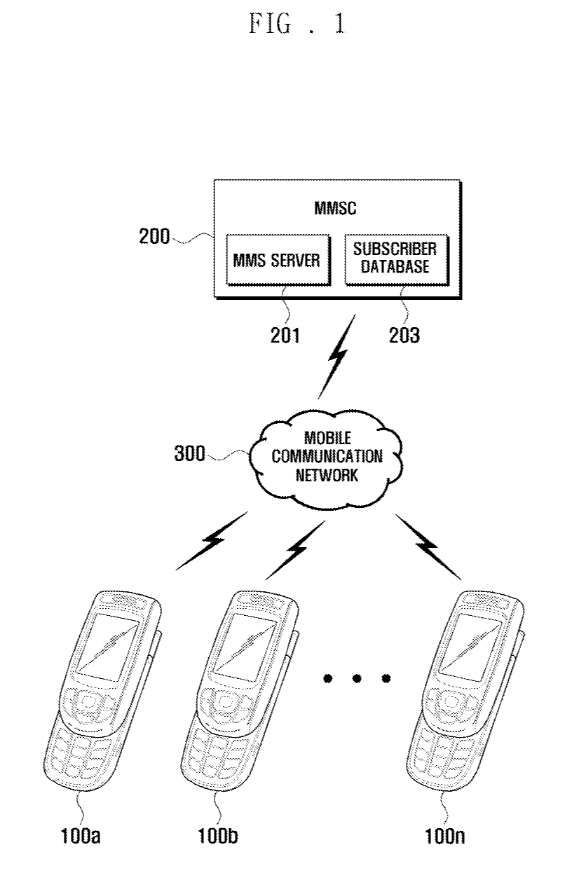

FIG. 1 illustrates communication between mobile terminals for composite photographing according to an exemplary embodiment of the present invention.

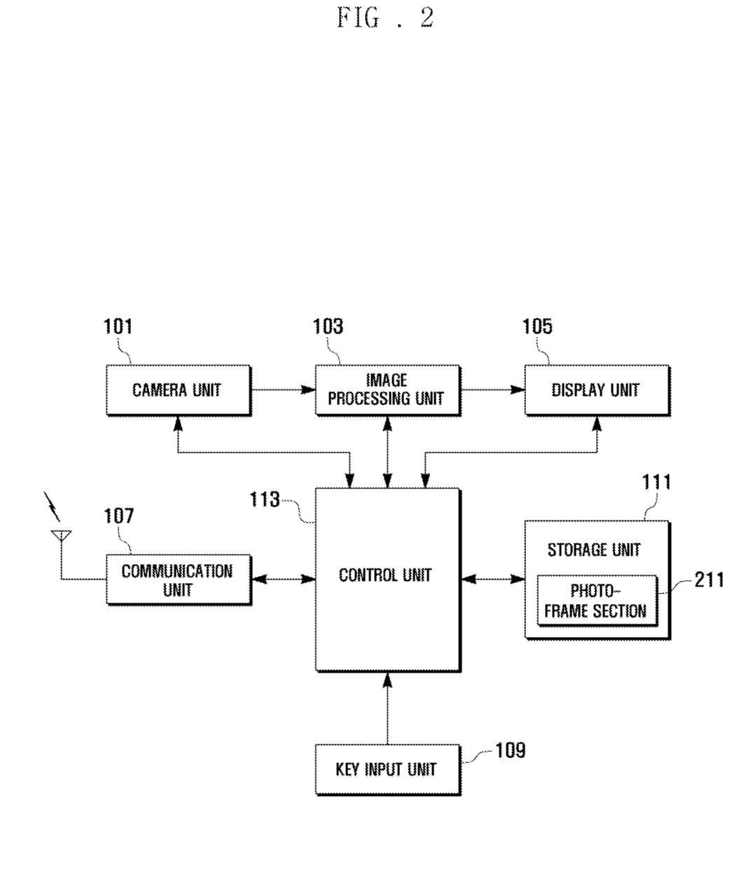

Referring to FIG. 1, the system for transmission of component images and production of a composite photograph includes a plurality of mobile terminals 100a to 100n, and a Multimedia Message Service Center (MMSC) 200. In FIG. 1, each of the mobile terminals 100a to 100n includes a communication unit (107 in FIG. 2) that is implemented with a Radio Frequency (RF) module. That is, the mobile terminals 100a to 100n communicate with the MMSC 200 using their RF modules. In the flowing description, FIG. 1 is not applied to the case where the mobile terminals 100a to 100n each include a communication unit implemented with a short-range wireless module. FIG. 1 can be applied to the case where the mobile terminals 100a to 100n each include a communication unit implemented with both a short-range wireless module and RF module.

The mobile terminals 100a to 100n each can make a voice call, use a Short Message Service (SMS), Multimedia Message Service (MMS) and Enhanced Message Service (EMS), and include an MP3 player for playback of a desired song. The mobile terminals 100a to 100n each can include a camera unit (101 in FIG. 2) to take a picture of a target object.

One of the mobile terminals 100a to 100n can take a picture through a camera unit for a composite photograph, and send an MMS message containing the taken picture to another one thereof. That is, the first mobile terminal 100a sends to the MMSC 200 an MMS message containing a picture with a request for delivery of the MMS message containing a picture to the second mobile terminal 100b. The MMSC 200 sends a reply to the first mobile terminal 100a, and sends an MMS notification to the second mobile terminal 100b. The second mobile terminal 100b sends a reply to the MMSC 200, connects to the MMSC 200, and retrieves the corresponding MMS message together with information on the first mobile terminal 100a.

In the following description, the first mobile terminal 100a acts as a master mobile terminal that initiates composite photographing by composing an MMS message containing a picture for a composite photograph, and a participant list. The remaining mobile terminals 100b to 100n act as slave mobile terminals that receive an incomplete composite photograph and insert a taken picture into the incomplete composite photograph. The mobile terminal 100n acts as a mobile terminal that produces a final composite photograph by inserting a taken picture into the incomplete composite photograph.

In composite shot mode, the first mobile terminal 100a, which acts as the master mobile terminal, takes a picture, prepares an incomplete composite photograph by inserting the taken picture into a photo-section of the incomplete composite photograph, and generates a list of mobile terminals participating in composite photographing (i.e. a participant list including the mobile terminals 100b to 100n). Then, the first mobile terminal 100a selects a slave mobile terminal in the participant list, for example the second mobile terminal 100b, and sends the incomplete composite photograph, participant list and sender terminal information on the first mobile terminal 100a through the MMSC 200 to the second mobile terminal 100b. Upon reception, the second mobile terminal 100b takes a picture and inserts the taken picture into a photo-section of the received incomplete composite photograph. When the resulting composite photograph has an empty photo-section (i.e. still incomplete), the second mobile terminal 100b selects another mobile terminal in the participant list, for example the third mobile terminal 100c, and sends the incomplete composite photograph, participant list and sender terminal information on the first and second mobile terminals 100a and 100b through the MMSC 200 to the third mobile terminal 100c.

Finally after repeating similar steps, the n-th mobile terminal 100n takes a picture, obtains a complete composite photograph by inserting the picture into a photo-section of the incomplete composite photograph, and sends the complete composite photograph through the MMSC 200 to the mobile terminals 100a to 100n−1 in the participant list.

The mobile terminals 100a to 100n are connected to the MMSC 200 through a mobile communication network 300. The mobile communication network 300 is a wired/wireless communication network, and may be a network using telephone lines, coaxial cables or optical fibers, a packet switched network, an Integrated Services Digital Network (ISDN), a broadband-ISDN, and the like.

The MMSC 200 is a message service system that can provide not only basic services including voice messages and short text messages but also various multimedia services including Internet electronic mails. The MMSC 200 receives a composite photograph from a mobile terminal and sends the received composite photograph to another mobile terminal. The MMSC 200 includes an MMS server 201 and a subscriber database 203.

The MMS server 201 defines roles of components in the MMSC 200, and controls the components. The MMS server 201 handles and stores MMS messages to be transmitted. The subscriber database 203 contains subscriber specific information, and provides information on delivery and rendering schemes for MMS messages. The subscriber specific information may include subscription information and addressing information of users or subscribers. The MMSC 200 may further include an MMS relay for transferring messages between different messaging systems, an MMS message storage for storing messages, and an MMS user agent for displaying final results of a process in the MMS architecture.

Next, a description is given of a mobile terminal for composite photographing. FIG. 2 is a block diagram illustrating a mobile terminal capable of producing a composite photograph according to an exemplary embodiment of the present invention.

Referring to FIG. 2, the mobile terminal includes a camera unit 101, image processing unit 103, display unit 105, communication unit 107, key input unit 109, storage unit 111, and control unit 113.

The camera unit 101 captures an image of a target object and generates a corresponding image signal. The camera unit 101 includes a lens for forming an image, an image sensor for converting an optical signal corresponding to the formed image into an electrical signal, and an image signal processor for converting the analog electrical signal from the image sensor into digital data. More particularly, when in composite shot mode, the camera unit 101 takes a picture to be inserted into a photo-section of a multi-photo frame. The camera unit 101 may take one or more pictures for the multi-photo frame.

The image processing unit 103 generates screen data to display an image signal from the camera unit 101. The image processing unit 103 includes an image codec to compress image data in a preset format or to decompress compressed image data, for display on the display unit 105.

The display unit 105 displays various information related to the state and operation of the mobile terminal. In particular, the display unit 105 displays a screen for a composite photograph during a composite shot mode. The composite photograph may include an image or characters related to an image. In an exemplary embodiment, for a composite photograph, the composite shot mode is entered after activation of the camera unit 101, a multi-photo framing function is selected during composite shot mode, and a picture of a target object is taken. That is, the display unit 105 displays a multi-photo frame during the composite shot mode. The display unit 105 displays a picture that was taken for a photo-section of the multi-photo frame according to a user input. A master mobile terminal initiating composite photographing displays a participant list screen on the display unit 105.

A slave mobile terminal displays a received composite photograph on the display unit 105, and displays, if the received composite photograph is incomplete, an image composition screen according to a user input. That is, the display unit 105 displays a picture that was taken for a selected photo-section of the multi-photo frame.

As described further below, when the communication unit 107 is a short-range wireless module such as a Bluetooth module, in order to send a composite photograph, the display unit 105 displays a list of Bluetooth device addresses found by inquiry and response procedures between Bluetooth-enabled devices. After issuing a remote name request, if remote names of the found devices are available, the display unit 105 displays a list of the remote names.

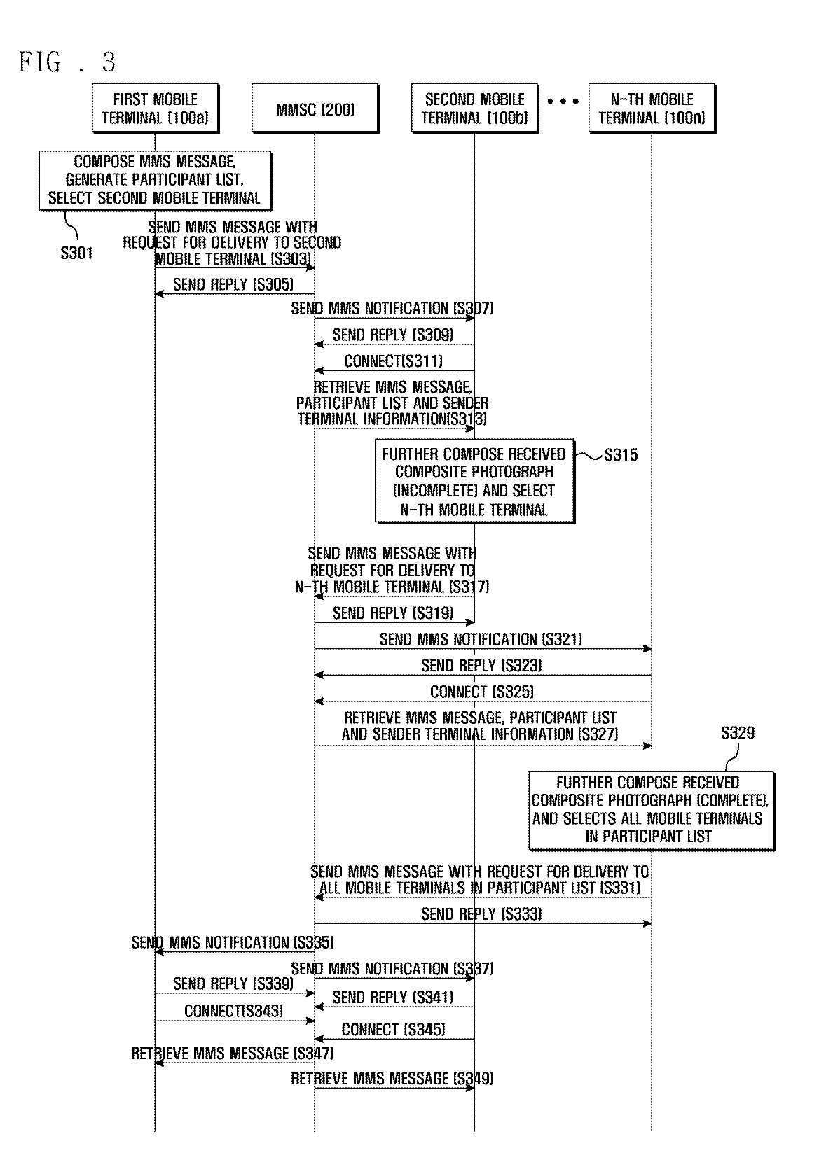

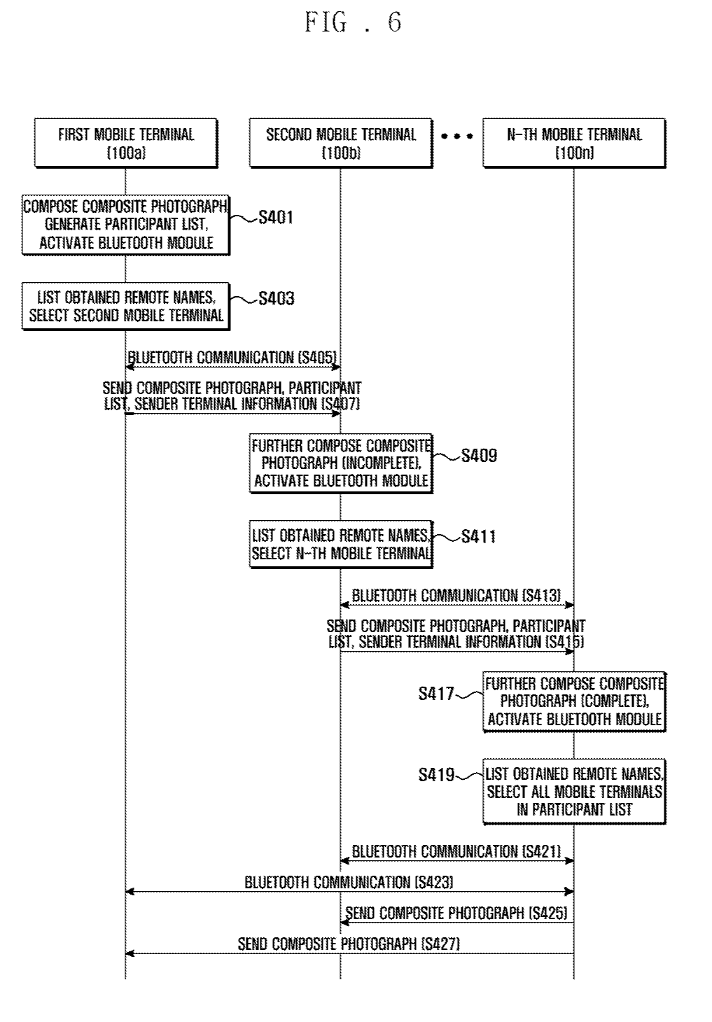

The communication unit 107 can be implemented as at least one of an RF module and a short-range wireless module to establish a wireless channel. FIGS. 3 and 5 are related to the composite photographing method in the case of the communication unit 107 being implemented as an RF module, and FIG. 6 is related to the composite photographing method in the case of the communication unit 107 being implemented as a short-range wireless module such as a Bluetooth module. The communication unit 107 may be implemented to include both an RF module as a first unit and a short-range wireless module as a second unit.

When the communication unit 107 is implemented as an RF module, it includes an RF transmitter for upconverting the frequency of a signal to be transmitted and amplifying the signal, and an RF receiver for low-noise amplifying a received signal and downconverting the frequency of the received signal.

When the communication unit 107 is implemented as a short-range wireless module, for example, a Bluetooth module, it can connect to a Bluetooth-enabled device through Bluetooth communication. The short-range wireless module may be any wireless module that can establish a short-range wireless channel for signal exchange, such as a Bluetooth module, IrDA module or Zigbee module.

The Bluetooth protocol operates in the Industrial, Scientific and Medical (ISM) band of 2.4 GHz, and this ISM band is a license-free band. Bluetooth employs a 2 MHz wide lower guard band and a 3.5 MHz wide upper guard band to reduce interference. Bluetooth uses frequency hopping with a hopping rate of 1600 hops per second.

The Bluetooth module collects information on discovered Bluetooth-enabled devices. The collected information may include a Bluetooth address (BD_ADDR), which is a device specific address, device class, page scan repetition mode, and clock offset of a connectable device. By issuing a remote name request to each discovered device, the Bluetooth module may receive a user friendly name of the discovered device as a reply.

The key input unit 109 receives an input signal from the user for controlling the operation of the mobile terminal. In particular, the key input unit 109 receives user input signals for selecting the composite shot mode, composing a composite photograph, activating the camera unit 101, selecting a multi-photo frame, taking a picture of a target object, generating a participant list, and selecting a mobile terminal to which the composite photograph is to be sent.

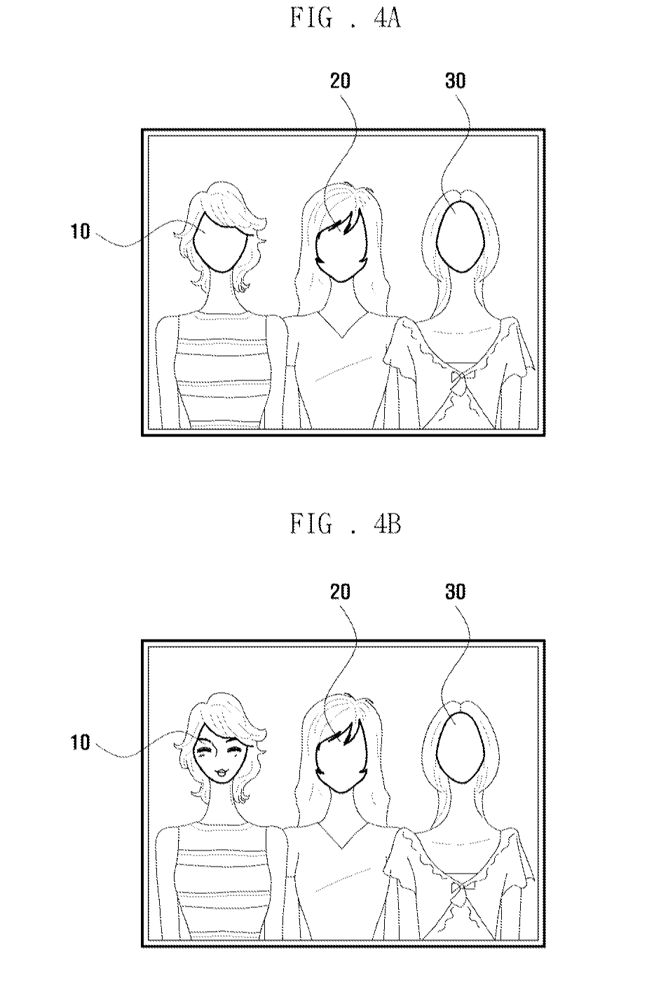

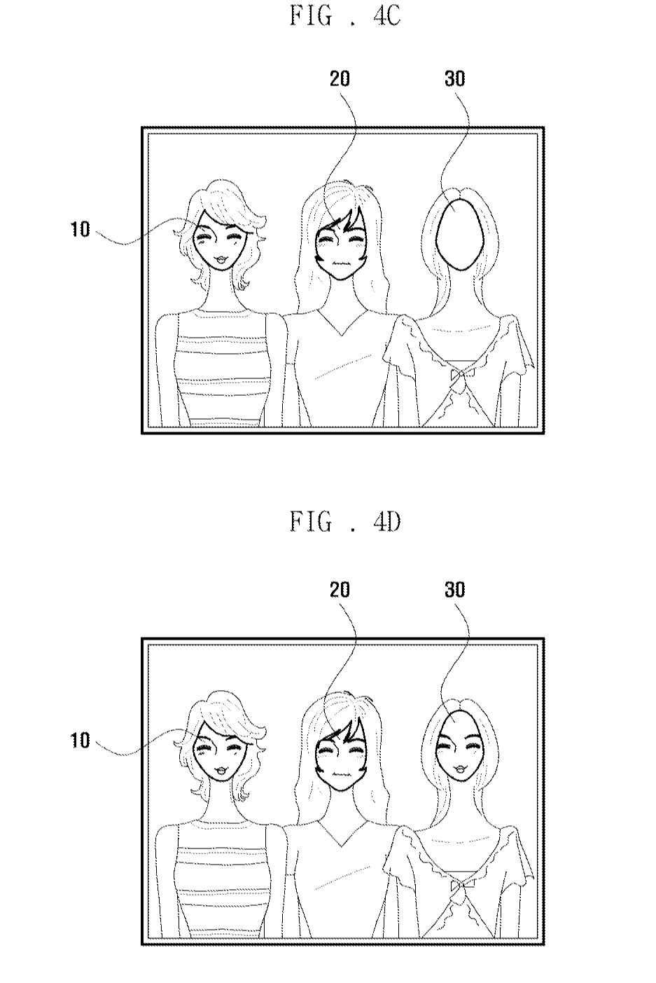

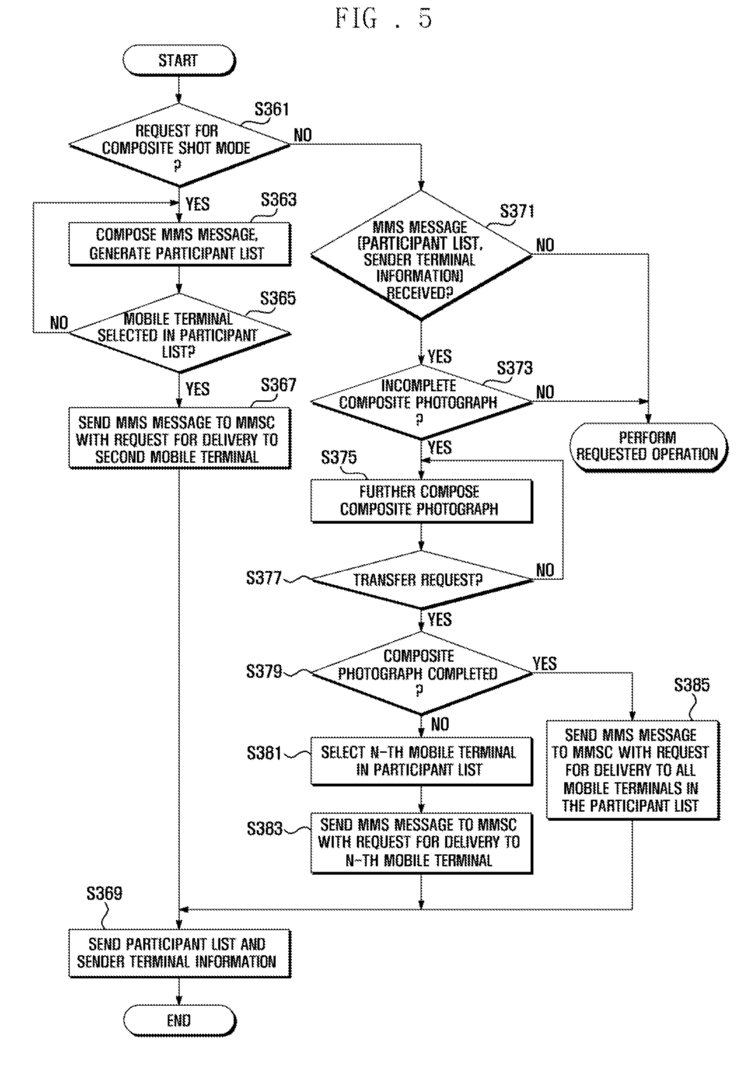

The storage unit 111 stores programs and data necessary for the operation of the mobile terminal. In particular, the storage unit 111 includes a photo-frame section 211 for the composite shot mode after activation of the camera unit 101. The photo-frame section 211 stores composite photographs in the form of a multi-photo frame, as illustrated in FIG. 4A, which includes multiple photo-sections each accommodating a picture. Multi-photo frames may be pre-stored in the storage unit 111 at the manufacturing process, or may be received from the outside.

The control unit 113 controls overall operations of components in the mobile terminal. In particular, the control unit 113 controls the composite photographing function based on multiple mobile terminals. For the first mobile terminal 100a, the control unit 113 composes an incomplete composite photograph and generates a participant list. Here, composition of an incomplete composite photograph indicates insertion of a taken picture into at least one photo-section of a given multi-photo frame during the composite shot mode. This involves selection of a multi-photo frame as illustrated in FIG. 4A, and insertion of a taken picture into a photo-section as illustrated in FIG. 4B. The control unit 113 sends the incomplete composite photograph to a selected mobile terminal in the participant list.

For the second mobile terminal 100b, in response to reception of an incomplete composite photograph, participant list and sender terminal information, the control unit 113 further composes the incomplete composite photograph. After the composition, the incomplete composite photograph may become complete without an empty photo-section in the multi-photo frame, or may remain incomplete with an empty photo-section. When the composite photograph is complete, the control unit 113 sends the complete composite photograph to all the mobile terminals in the participant list, for example, the first mobile terminal 100a. If the composite photograph remains incomplete, the control unit 113 sends the incomplete composite photograph, participant list, and sender terminal information on the first and second mobile terminals 100a and 100b to another mobile terminal in the participant list that has not yet participated in the composite photographing.

For the n-th mobile terminal 100n, in response to reception of an incomplete composite photograph, participant list and sender terminal information, the control unit 113 further composes the incomplete composite photograph. When the composite photograph is complete, the control unit 113 sends the complete composite photograph to all the mobile terminals in the participant list. Here, completeness of a composite photograph may be determined by determining the presence of an empty photo-section in the multi-photo frame. The mobile terminals in the participant list are those mobile terminals that have participated in composite photographing.

When the communication unit 107 is a Bluetooth module, in order to send a composite photograph, the control unit 113 activates the Bluetooth module and controls the Bluetooth module to issue an inquiry to find a Bluetooth-enabled mobile terminal. If a response is received, the Bluetooth module issues a remote name request to the discovered mobile terminal. Upon reception of a response, the control unit 113 lists the user friendly name of the discovered mobile terminal on the display unit 105. Thereafter, the control unit 113 selects one of listed mobile terminals, performs pairing with the selected mobile terminal, establishes a Bluetooth connection to the selected mobile terminal, and sends the composite photograph.

Next, a description is given of a composite photographing method using multiple mobile terminals. FIGS. 3 and 5 are related to the case where the communication unit is implemented as an RF module. FIG. 3 is a sequence diagram of a first composite photographing method using mobile terminals based on RF communication according to an exemplary embodiment of the present invention. FIGS. 4A to 4D are screen representations illustrating steps in the first composite photographing method according to an exemplary embodiment of the present invention.

Referring to FIG. 3, the first mobile terminal 100a composes an MMS message containing a composite photograph, generates a participant list, and selects the second mobile terminal 100b in step S301. In this step, the first mobile terminal 100a composes an incomplete composite photograph. That is, the first mobile terminal 100a inserts a picture that was taken into at least one photo-section of a given multi-photo frame during a composite shot mode. A screen for a composed composite photograph is illustrated in FIG. 4B. The first mobile terminal 100a selects a multi-photo frame as illustrated in FIG. 4A, takes a facial picture of the user or another person, and inserts the picture into a first photo-section 10 as illustrated in FIG. 4B.

Then, the first mobile terminal 100a generates a list of mobile terminals carried by participants of the composite photographing. The participants may be family members of the user of the first mobile terminal 100a. To produce a family photograph for family members at distinct locations, the user of the first mobile terminal 100a takes the facial picture as illustrated in FIG. 4B, generates a participant list of mobile terminals carried by family members, and selects a mobile terminal, for example the second mobile terminal 100b, in the participant list. The participant list may be made through a menu or option key available after composition of the composite photograph.

Thereafter, the first mobile terminal 100a sends, to the MMSC 200, the composed MMS message containing the composite photograph with a request for delivery of composed MMS message containing the composite photograph to the second mobile terminal 100b in step S303. The MMSC 200 sends a reply to the first mobile terminal 100a in step S305.

The MMSC 200 sends an MMS notification to the second mobile terminal 100b in step S307, and the second mobile terminal 100b sends a reply to the MMSC 200 in step S309.

The second mobile terminal 100b connects to the MMSC 200 in step S311, and retrieves the corresponding MMS message together with the participant list and the sender terminal information on the first mobile terminal 100a in step S313. Here, the sender terminal information includes a telephone number of the first mobile terminal 100a.

The second mobile terminal 100b further composes the received composite photograph, and selects the n-th mobile terminal 100n as the recipient for an MMS message containing the composed composite photograph in step S315. The composite photograph composed at this step is illustrated in FIG. 4C. That is, the second mobile terminal 100b receives the composite photograph with the non-empty first photo-section 10 as illustrated in FIG. 4B, and further composes the composite photograph by taking a facial picture and inserting the picture into a second photo-section 20 of the composite photograph as illustrated in FIG. 4C. The second mobile terminal 100b selects the n-th mobile terminal 100n in the participant list as the recipient for the composed composite photograph.

The second mobile terminal 100b sends, to the MMSC 200, an MMS message containing the composite photograph with a request for delivery of the MMS message containing the composite photograph to the n-th mobile terminal 100n in step S317. The MMSC 200 sends a reply to the second mobile terminal 100b in step S319.

The MMSC 200 sends an MMS notification to the n-th mobile terminal 100n in step S321, and the n-th mobile terminal 100n sends a reply to the MMSC 200 in step S323.

The n-th mobile terminal 100n connects to the MMSC 200 in step S325, and retrieves the corresponding MMS message together with the participant list and the sender terminal information on the first and second mobile terminals 100a and 100b in step S327. In the participant list, each listed mobile terminal may have a checkbox. When the second mobile terminal 100b further composes a composite photograph as described above, it can place a checkmark in the associated checkbox and send the composed composite photograph and the participant list to the n-th mobile terminal 100n. In other words, after a mobile terminal further composes a composite photograph, the mobile terminal places a checkmark in the associated checkbox of the participant list and sends both the participant list and the composed composite photograph to the next mobile terminal. Hence, the next mobile terminal receiving the composite photograph and participant list can easily identify a mobile terminal that has participated in composite photographing, and select a next mobile terminal in the participant list to which the composite photograph is to be sent.

The n-th mobile terminal 100n produces a complete composite photograph by further composing the received composite photograph, and selects all the mobile terminals in the participant list in step S329. The composite photograph completed in this step is illustrated in FIG. 4D. That is, the n-th mobile terminal 100n receives the composite photograph with the non-empty first and second photo-section 10 and 20 as illustrated in FIG. 4C, and further composes the composite photograph by taking a facial picture and inserting the picture into a third photo-section 30 of the composite photograph as illustrated in FIG. 4D. The n-th mobile terminal 100n selects all the mobile terminals in the participant list (first and second mobile terminals 100a and 100b) as recipients for the complete composite photograph.

The n-th mobile terminal 100n sends, to the MMSC 200, an MMS message containing the complete composite photograph with a request for delivery of the MMS message containing the complete composite photograph to all the mobile terminals in the participant list (first and second mobile terminals 100a and 100b) in step S331. The MMSC 200 sends a reply to the n-th mobile terminal 100n in step S333.

The MMSC 200 sends an MMS notification to the first mobile terminal 100a in step S335 and to the second mobile terminal 100b in step S337. The first mobile terminal 100a sends a reply to the MMSC 200 in step S339, and the second mobile terminal 100b sends a reply to the MMSC 200 in step S341.

The first mobile terminal 100a connects to the MMSC 200 in step S343, and retrieves the corresponding MMS message in step S347. The second mobile terminal 100b connects to the MMSC 200 in step S345, and retrieves the corresponding MMS message in step S349.

In the above description, three mobile terminals participate in composite photographing. However, the present invention is not limited thereto, and the number of participating mobile terminals may vary depending upon the number of photo-sections in a given multi-photo frame or the number of entries in the participant list. In addition, production of a composite photograph is not limited to selection of a particular function related to multi-photo framing.

Next, another description is given of the first composite photographing method using multiple mobile terminals. FIG. 5 is a flowchart of the first composite photographing method using mobile terminals based on RF communication according to an exemplary embodiment of the present invention.

Referring to FIG. 5, the control unit 113 of the first mobile terminal 100a determines whether a request for a composite shot mode is issued in step S361. In the composite shot mode, the camera unit 101 is activated and a multi-photo frame is displayed as illustrated in FIG. 4A.

When the request for the composite shot mode is issued, the control unit 113 composes an MMS message containing a composite photograph, and generates a participant list in step S363. At this step, as illustrated in FIG. 4B, the first mobile terminal 100a composes an incomplete composite photograph by inserting a picture into a first photo-section 10 of a given multi-photo frame. The participant list is a list of mobile terminals participating in composite photographing.

The control unit 113 determines whether a mobile terminal in the participant list is selected in step S365. It is assumed that the user selects the second mobile terminal 100b as a recipient for the composite photograph. If no mobile terminal is selected, the control unit 113 returns to step S363.

When the second mobile terminal 100b is selected, the control unit 113 sends an MMS message containing the composite photograph to the MMSC 200 with a request for delivery of the MMS message containing the composite photograph to the second mobile terminal 100b in step S367. The control unit 113 sends the participant list and sender terminal information to the MMSC 200 in step S369.

When the request for composite shot mode is not issued at step S361, the control unit 113 determines whether an MMS message containing a composite photograph is received in step S371. A participant list and sender terminal information may be received together with the composite photograph.

When an MMS message containing a composite photograph is received, the control unit 113 determines whether the composite photograph is complete in step S373. As described in connection with FIG. 3, the received composite photograph may be an incomplete one from, for example, the second mobile terminal 100b, or may be a complete one from, for example, the n-th mobile terminal 100n. The control unit 113 can determine the completeness of a composite photograph by detecting the presence of an empty photo-section in the composite photograph (i.e. multi-photo frame). If the received composite photograph is complete as in the case of FIG. 4D, the control unit 113 performs an operation according to a user input. For example, the control unit 113 stores the received composite photograph in the storage unit 111.

If the received composite photograph is incomplete, the control unit 113 further composes the composite photograph in step S375. That is, if the received composite photograph is incomplete as in the case of FIG. 4B or 4C, the control unit 113 activates the camera unit 101 to take a picture, inserts the picture into an empty photo-section of the composite photograph, and stores the composite photograph.

The control unit 113 determines whether a request to transfer the composed composite photograph is issued in step S377. If the transfer request is issued, the control unit 113 determines whether the composed composite photograph is complete in step S379. As described in connection with FIG. 3, the composite photograph composed at step S375 may be an incomplete one from, for example, the second mobile terminal 100b, or be a complete one from, for example, the n-th mobile terminal 100n. That is, the composite photograph composed at step S375 may be incomplete as in the case of FIG. 4C, or be complete as in the case of FIG. 4D. The control unit 113 regards a composite photograph as being complete when an empty photo-section is not present in the composite photograph.

If the composed composite photograph is incomplete, the control unit 113 selects a mobile terminal in the participant list, for example the n-th mobile terminal 100n, in step S381. The control unit 113 regards a composite photograph being incomplete when an empty photo-section is present in the composite photograph. The control unit 113 selects a mobile terminal in the participant list and not yet participated in composite photographing.

The control unit 113 sends an MMS message containing the composite photograph to the MMSC 200 with a request for delivery of the MMS message containing the composite photograph to the n-th mobile terminal 100n in step S383, and proceeds to step S369.

If the composed composite photograph is incomplete at step S379, the control unit 113 sends an MMS message containing the composite photograph to the MMSC 200 with a request for delivery of the MMS message containing the composite photograph to all mobile terminals in the participant list in step S385. Here, it is assumed that the participant list mobile and the sender terminal information identify the same mobile terminals. When the participant list mobile and the sender terminal information do not identify the same mobile terminals, the complete composite photograph is sent to those mobile terminals identified by the sender terminal information, which have actually participated in composite photographing. It may be possible that a mobile terminal in the participant list does not participate in composite photographing.

Thereafter, the control unit 113 proceeds to step S369.

Next, another description is given of the first composite photographing method using multiple mobile terminals. FIG. 6 is a sequence diagram of the first composite photographing method using mobile terminals based on short-range communication according to an exemplary embodiment of the present invention. In FIG. 6, mobile terminals use Bluetooth communication as the short-range communication for composite photographing.

Referring to FIG. 6, the first mobile terminal 100a composes an incomplete composite photograph, generates a participant list, and activates the Bluetooth module to select a mobile terminal as a recipient of the composite photograph in step S401.

The first mobile terminal 100a lists obtained remote names of mobile terminals, and selects, for example, the second mobile terminal 100b in the participant list based on the obtained remote names in step S403. The first mobile terminal 100a activates the Bluetooth module, discovers Bluetooth-enabled mobile terminals, issues a remote name request to the discovered mobile terminals, obtains remote names from those responding mobile terminals, and displays the obtained remote names. The first mobile terminal 100a uses the obtained remote names to select, for example, the second mobile terminal 100b in the participant list.

The first mobile terminal 100a performs pairing with the second mobile terminal 100b, and establishes a Bluetooth connection thereto in step S405. The first mobile terminal 100a sends the composite photograph, participant list, and sender terminal information on the first mobile terminal 100a to the second mobile terminal 100b in step S407.

The second mobile terminal 100b further composes the received composite photograph, and activates the Bluetooth module to transfer the composed composite photograph in step S409.

The second mobile terminal 100b lists obtained remote names of mobile terminals, and selects, for example, the n-th mobile terminal 100n in the participant list based on the obtained remote names in step S411.

The second mobile terminal 100b performs pairing with the n-th mobile terminal 100n, and establishes a Bluetooth connection thereto in step S413. The second mobile terminal 100b sends the composite photograph, participant list, and sender terminal information on the first and second mobile terminals 100a and 100b to the n-th mobile terminal 100n in step S415.

The n-th mobile terminal 100n further composes the received composite photograph, and activates the Bluetooth module to transfer the composed composite photograph in step S417.

The n-th mobile terminal 100n lists obtained remote names of mobile terminals, and selects all mobile terminals in the participant list based on the obtained remote names in step S419. Here, the mobile terminals in the participant list are those having participated in composite photographing (for example, the first and second mobile terminals 100a and 100b).

The n-th mobile terminal 100n performs pairing with the second mobile terminal 100b and establishes a Bluetooth connection thereto in step S421, and sends the composite photograph to the second mobile terminal 100b in step S425. The n-th mobile terminal 100n performs pairing with the first mobile terminal 100a and establishes a Bluetooth connection thereto in step S423, and sends the composite photograph to the first mobile terminal 100a in step S427.

Next, a description is given of a second composite photographing method using multiple mobile terminals. Descriptions of elements that are substantially the same as or corresponding to those of the first composite photographing method are omitted.

In the second composite photographing method, the master mobile terminal sends a composite photograph to one or more slave mobile terminals in the participant list, each of the slave mobile terminals further composes the composite photograph and sends the incomplete composite photograph to the master mobile terminal, and the master mobile terminal combines the incomplete composite photographs together into a final composite photograph.

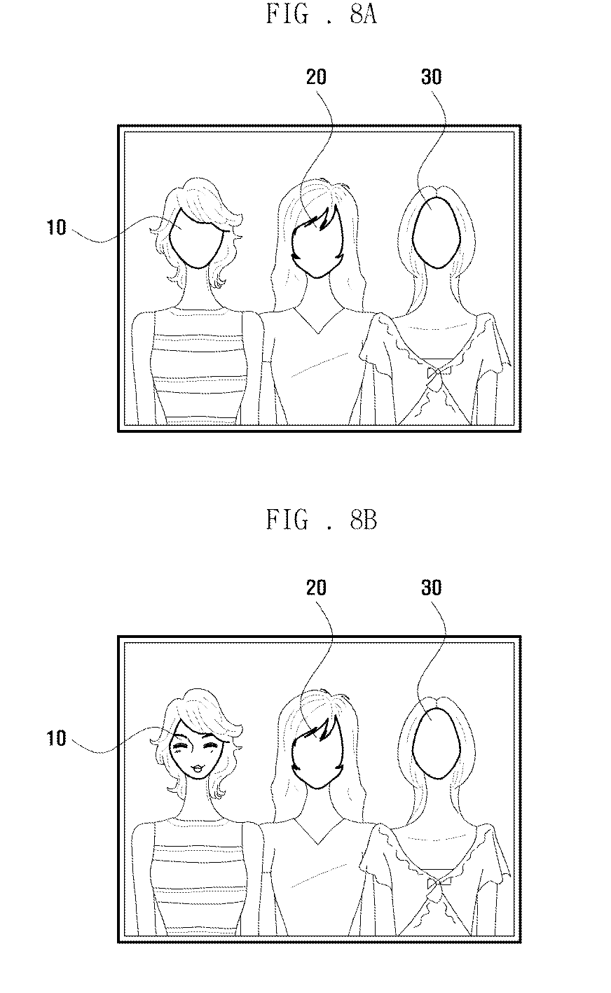

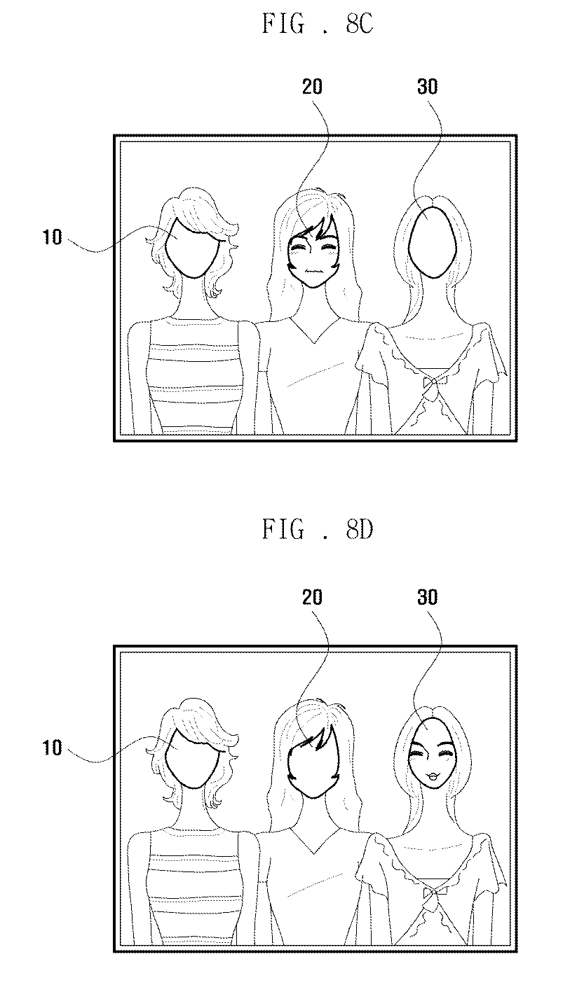

Referring back to FIG. 1, one of the mobile terminals 100a to 100n can take a picture through a camera unit to form an initial composite photograph, and send an MMS message containing the composite photograph to another one thereof. That is, the first mobile terminal 100a acting as the master sends the MMSC 200 an MMS message containing a composite photograph with a request for delivery of the MMS message containing a composite photograph to the second to n-th mobile terminals 100b to 100n acting as slaves. Here, the composite photograph may be in a first form having a photo-section filled with a picture taken by the first mobile terminal 100a (as illustrated in FIG. 8B), or in a second form not having a photo-section filled with a picture taken by the first mobile terminal 100a (as illustrated in FIG. 8A). When the composite photograph is sent, photo-section information is also sent to the second to n-th mobile terminals 100b to 100n.

Upon reception of the MMS message, the MMSC 200 sends a reply to the first mobile terminal 100a, and sends an MMS notification to the second to n-th mobile terminals 100b to 100n. Each of the second to n-th mobile terminals 100b to 100n sends a reply to the MMSC 200, connects to the MMSC 200, and retrieves the corresponding MMS message containing the composite photograph together with the sender terminal information of the first mobile terminal 100a and photo-section information. The photo-section information is given by the first mobile terminal 100a, and indicates a photo-section of a composite photograph (or multi-photo frame) into which a receiving mobile terminal (second to n-th mobile terminals 100b to 100n) is to insert a picture.

Each of the second to n-th mobile terminals 100b to 100n further composes the received composite photograph by taking a picture and inserting the picture into the photo-section of the composite photograph indicated by the photo-section information. The second to n-th mobile terminals 100b to 100n send their composed composite photographs to the first mobile terminal 100a, which then combines the received composite photographs together into a complete composite photograph. Thereafter, the first mobile terminal 100a can send the complete composite photograph to the second to n-th mobile terminals 100b to 100n having participated in composite photographing.

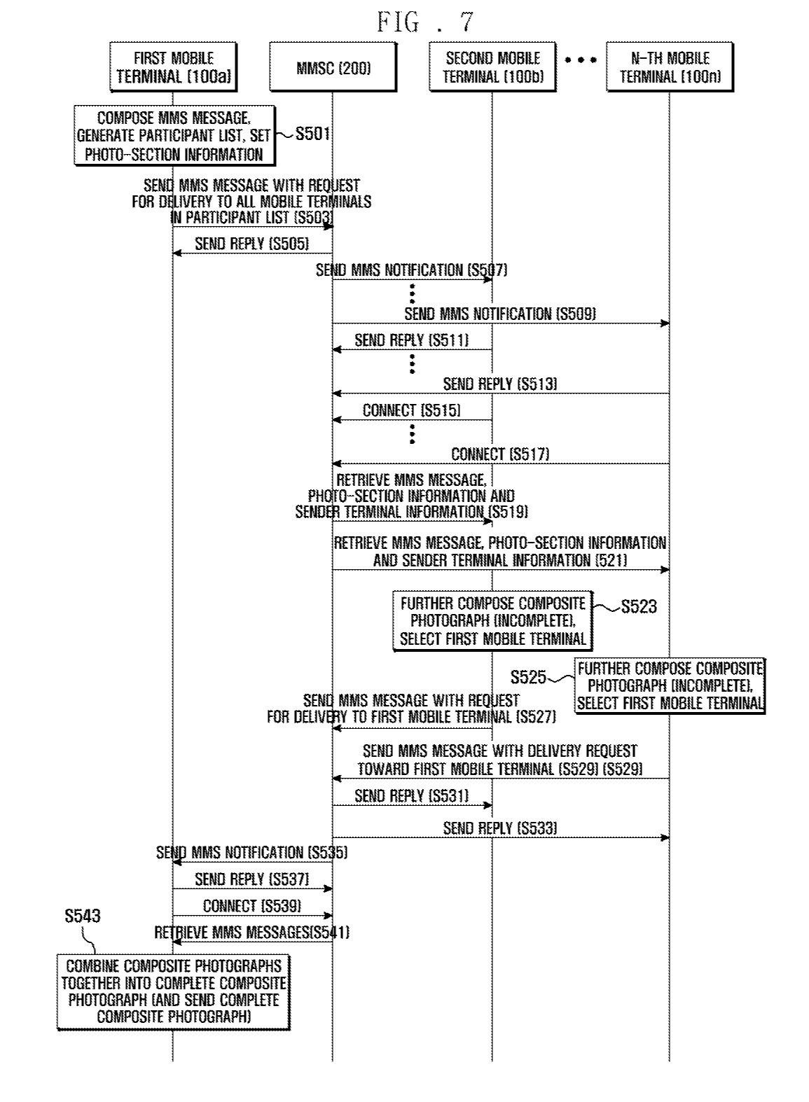

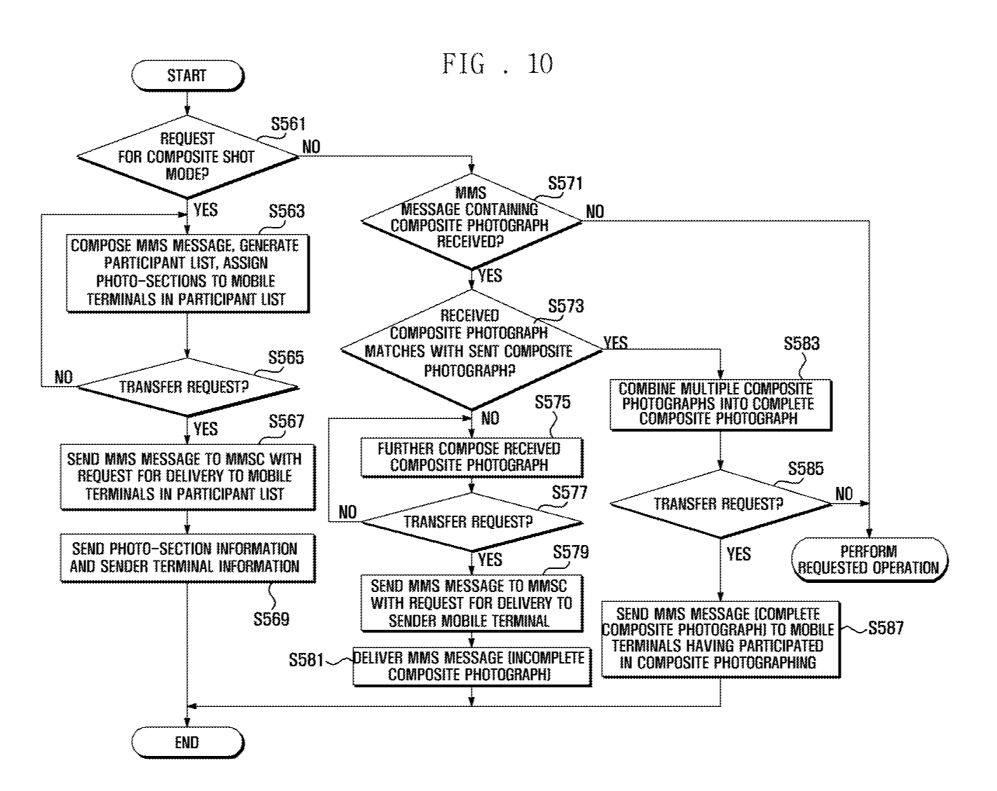

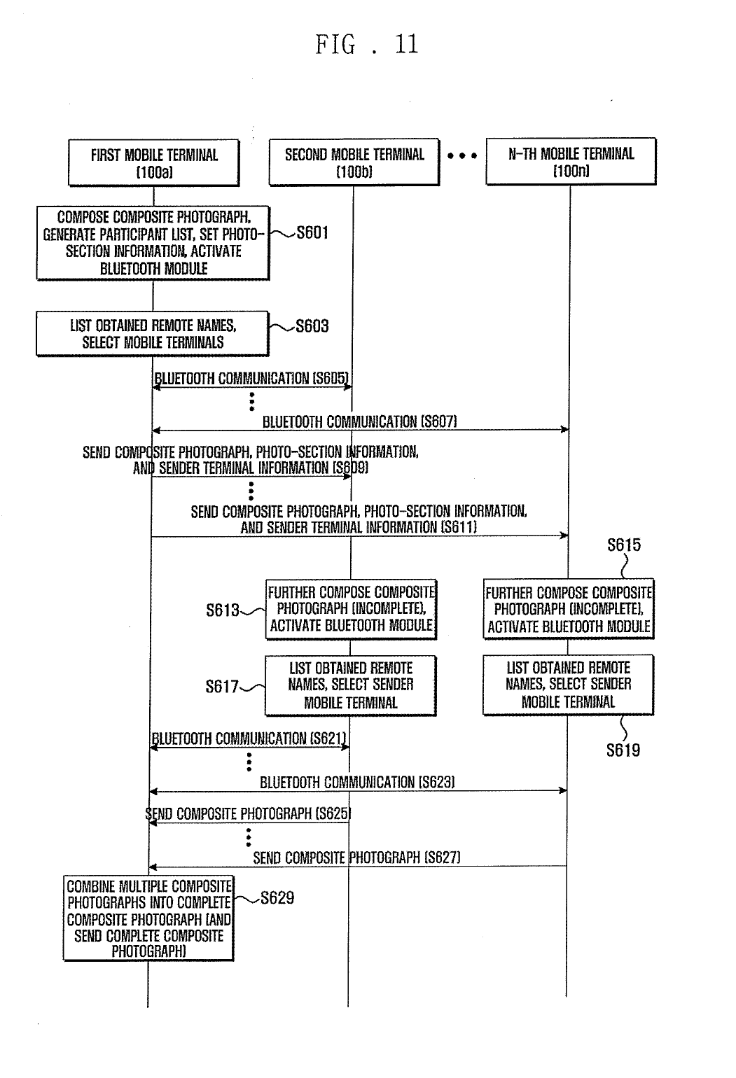

Referring to FIG. 2, the communication unit 107 can be implemented as at least one of an RF module and a short-range wireless module. FIGS. 7 and 10 are related to the second composite photographing method in the case of the communication unit 107 being implemented as an RF module, and FIG. 11 is related to the second composite photographing method in the case of the communication unit 107 being implemented as a short-range wireless module like a Bluetooth module.

For the first mobile terminal 100a acting as the master, the control unit 113 composes an incomplete composite photograph, generates a participant list, and sets photo-section information. Here, composition of an incomplete composite photograph indicates insertion of a taken picture into at least one photo-section of a given multi-photo frame during composite shot mode. The photo-section information specifies a mobile terminal that inserts a picture into each photo-section of the multi-photo frame. The control unit 113 sends the composite photograph and photo-section information to at least one slave mobile terminal in the participant list. Upon reception of composite photographs from the second to n-th mobile terminals 100b to 100n, the control unit 113 combines the received composite photographs together into a complete composite photograph. Thereafter, the control unit 113 can send the complete composite photograph to the second to n-th mobile terminals 100b to 100n.

For one of the second to n-th mobile terminals 100b to 100n acting as slaves, in response to reception of a composite photograph, participant list, photo-section information and sender terminal information, the control unit 113 further composes the received composite photograph by taking a picture and inserting the picture into a photo-section of the composite photograph indicated by the photo-section information. The control unit 113 then sends the composed composite photograph to the first mobile terminal 100a, which is the sender.

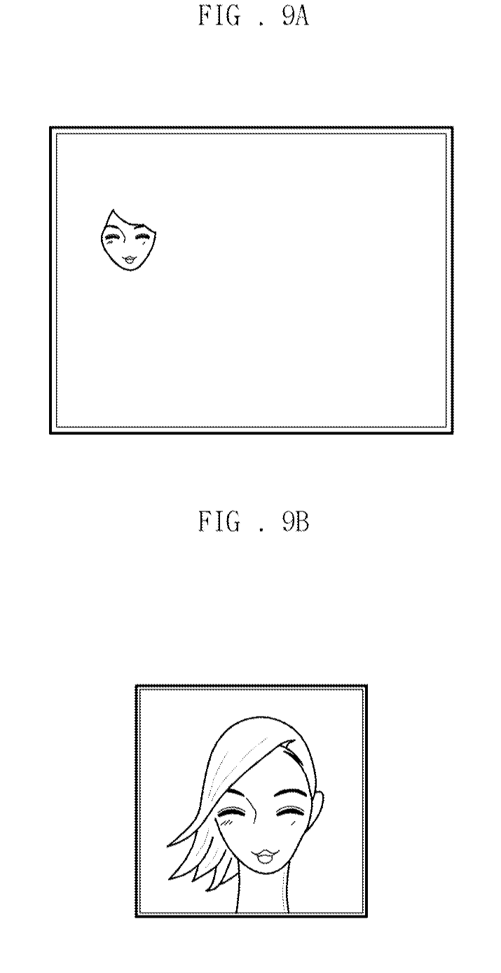

A composite photograph or multi-photo frame may take various forms. For example, a first type composite photograph may include both a framing image and a taken picture as illustrated in FIGS. 8B to 8D, a second type composite photograph may include only a taken picture as illustrated in FIG. 9A, and a third type composite photograph may include a taken picture and associated photo-section (not shown) in the framing image as illustrated in FIG. 9B.

That is, the first type composite photograph is transferred as a multi-photo frame whose photo-section includes a taken picture as illustrated in FIGS. 8B to 8D. The second type composite photograph is transferred as a multi-photo frame including a taken picture at a given position without a framing image as illustrated in FIG. 9A. The second type composite photograph is transferred as a taken picture with associated photo-section information.

In the case related to FIGS. 8A to 8D and FIGS. 9A and 9B, the first mobile terminal 100a sends a composite photograph including only a framing image to the second to n-th mobile terminals 100b to 100n. Namely, in a given multi-photo frame, the photo-section assigned to the first mobile terminal 100a is empty. Each of the second to n-th mobile terminals 100b to 100n inserts a taken picture into the assigned photo-section of a received multi-photo frame. When the first mobile terminal 100a sends a multi-photo frame having a taken picture at the assigned photo-section as a composite photograph, a facial picture taken by the first mobile terminal 100a should be present in, for example, the first photo-section 10 in FIG. 8C or 8D.

Next, a description is given of the second composite photographing method using multiple mobile terminals. FIGS. 7 and 10 are related to the case where the communication unit is implemented as an RF module.

FIG. 7 is a sequence diagram of the second composite photographing method using mobile terminals based on RF communication according to an exemplary embodiment of the present invention. FIGS. 8A to 8D are screen representations illustrating steps in the second composite photographing method according to an exemplary embodiment of the present invention. FIGS. 9A and 9B illustrate forms of a composite photograph transferable between mobile terminals according to an exemplary embodiment of the present invention.

Referring to FIG. 7, the first mobile terminal 100a composes an MMS message containing a composite photograph, generates a participant list, and sets photo-section information for each mobile terminal in the participant list in step S501. In this step, the first mobile terminal 100a composes an incomplete composite photograph. That is, the first mobile terminal 100a inserts a taken picture into at least one photo-section of a given multi-photo frame during composite shot mode. A screen for a composed composite photograph is illustrated in FIG. 8B. The first mobile terminal 100a selects a multi-photo frame as illustrated in FIG. 8A, takes a facial picture of the user or another person, and inserts the picture into a first photo-section 10 as illustrated in FIG. 8B.

Then, the first mobile terminal 100a generates a list of mobile terminals carried by participants in composite photographing. The participant list may be made through a menu or option key available after composition of the composite photograph. In addition, the first mobile terminal 100a sets photo-section information by assigning individual photo-sections to mobile terminals in the participant list. For example, the first mobile terminal 100a can select a multi-photo frame as illustrated in FIG. 8A, and assign a second photo-section 20 and a third photo-section 30 respectively to the first mobile terminal 100a and the n-th mobile terminal 100n. Assignment of a photo-section may be made through a menu or option key available for composite photographing.

Thereafter, the first mobile terminal 100a sends, to the MMSC 200, the composed MMS message containing the composite photograph with a request for delivery of the MMS message containing the composite photograph to the second to n-th mobile terminals 100b to 100n in step S503.

Here, as described before, the composite photograph may include a taken picture at a photo-section assigned to the first mobile terminal 100a as illustrated in FIG. 8B, or may not include a taken picture thereat as illustrated in FIG. 8A. In the following description, the first mobile terminal 100a sends a composite photograph including only a framing image as illustrated in FIG. 8A to the second to n-th mobile terminals 100b to 100n.

The MMSC 200 sends a reply to the first mobile terminal 100a in step S505. The MMSC 200 sends an MMS notification to the second to n-th mobile terminals 100b to 100n in steps S507 and S509, and the second to n-th mobile terminals 100b to 100n send a reply to the MMSC 200 in steps S511 and S513.

The second to n-th mobile terminals 100b to 100n connect to the MMSC 200 in steps S515 and S517, and retrieve the corresponding MMS message together with the photo-section information and the sender terminal information on the first mobile terminal 100a in steps S519 and S521.

Each of the second to n-th mobile terminals 100b to 100n further composes the received composite photograph, and selects the first mobile terminal 100a as the recipient in steps S523 and S525. The incomplete composite photographs composed by the second and n-th mobile terminals 100b and 100n are illustrated in FIGS. 8C and 8D. That is, the second mobile terminal 100b further composes the received composite photograph by inserting a taken picture into a second photo-section 20 as illustrated in FIG. 8C, and the n-th mobile terminal 100n further composes the received composite photograph by inserting a taken picture into a third photo-section 30 as illustrated in FIG. 8D. Thereafter, each of the second to n-th mobile terminals 100b to 100n selects the first mobile terminal 100a as the recipient for the composed composite photographs.

Each of the second to n-th mobile terminals 100b to 100n sends, to the MMSC 200, an MMS message containing the composite photograph with a request for delivery of the MMS message containing the composite photograph to the first mobile terminal 100a in steps S527 and S529. The MMSC 200 sends a reply to each of the second to n-th mobile terminals 100b to 100n in steps S531 and S533.

The MMSC 200 sends an MMS notification to the first mobile terminal 100a in step S535, and the first mobile terminal 100a sends a reply to the MMSC 200 in step S537.

The first mobile terminal 100a connects to the MMSC 200 in step S539, and retrieves the corresponding MMS messages in step S541. As described before, a composite photograph received at this step may take various forms. For example, a first type composite photograph may include both a framing image and a taken picture as illustrated in FIGS. 8B to 8D, a second type composite photograph may include only a taken picture as illustrated in FIG. 9A, and a third type composite photograph may include a taken picture and associated photo-section (not shown) in the framing image as illustrated in FIG. 9B.

The first mobile terminal 100a combines the received composite photographs together into a complete composite photograph in step S543. Later, the first mobile terminal 100a can send the complete composite photograph to the second to n-th mobile terminals 100b to 100n having participated in composite photographing.

In the description related to steps S535 to S541, an MMS notification, reply, connection and MMS retrieval are performed one time between the MMSC 200 and the first mobile terminal 100a. These operations may be performed once whenever an MMS message arrives at the MMSC 200 from the second to n-th mobile terminals 100b to 100n.

In the above description, three mobile terminals participate in composite photographing. However, the present invention is not limited thereto, and the number of participating mobile terminals may vary. In addition, production of a composite photograph is not limited to selection of a particular function related to multi-photo framing.

Next, another description is given of the second composite photographing method using multiple mobile terminals. FIG. 10 is a flowchart of the second composite photographing method using mobile terminals based on RF communication according to an exemplary embodiment of the present invention.

Referring to FIG. 10, the control unit 113 of the first mobile terminal 100a determines whether a request for a composite shot mode is issued in step S561. In composite shot mode, the camera unit 101 is activated and a multi-photo frame is displayed as illustrated in FIG. 8A.

When the request for composite shot mode is issued, the control unit 113 composes an MMS message containing a composite photograph, generates a participant list, and assigns photo-sections of the composite photograph to mobile terminals in the participant list in step S563. At this step, as illustrated in FIG. 8B, the control unit 113 composes an incomplete composite photograph by inserting a picture into a first photo-section 10. The participant list is a list of mobile terminals participating in composite photographing (second to n-th mobile terminals 100b to 100n). The control unit 113 assigns photo-sections of the composite photograph to the second to n-th mobile terminals 100b to 100n. For example, a second photo-section 20 and third photo-section 20 are assigned respectively to the second mobile terminal 100b and n-th mobile terminal 100n.

The control unit 113 determines whether a transfer request is issued in step S565. When the transfer request is issued, the control unit 113 sends an MMS message containing the composite photograph to the MMSC 200 with a request for delivery of the MMS message containing the composite photograph to mobile terminals in the participant list in step S567. The control unit 113 sends the photo-section information and sender terminal information to the MMSC 200 in step S569.

When the request for composite shot mode is not issued in step S561, the control unit 113 determines whether an MMS message containing a composite photograph is received in step S571. Photo-section information and sender terminal information may be received together with the composite photograph.

When the composite photograph is received, the control unit 113 determines whether the received composite photograph matches with the composite photograph having been sent in step S573. As described in connection with FIG. 7, the first mobile terminal 100a can send a composite photograph to the second to n-th mobile terminals 100b to 100n, and then receive a further composed composite photograph from each of the second to n-th mobile terminals 100b to 100n.

If the received composite photograph does not match with the composite photograph having been sent, the control unit 113 further composes the received composite photograph in step S575. As described in connection with FIG. 7 for the second to n-th mobile terminals 100b to 100n, each of the second to n-th mobile terminals 100b to 100n can receive a composite photograph as illustrated in FIG. 8A and further compose the received composite photograph. That is, the second mobile terminal 100b inserts a taken picture into the second photo-section 20 as illustrated in FIG. 8C, and the n-th mobile terminal 100n inserts a taken picture into the third photo-section 30 as illustrated in FIG. 8D.

The control unit 113 determines whether a request to transfer the composed composite photograph is issued in step S577. If a transfer request is issued, the control unit 113 sends an MMS message containing the composed composite photograph to the MMSC 200 with a request for delivery of the MMS message containing the composed composite photograph to the sender mobile terminal in step S579. The MMSC 200 delivers the MMS message to the sender mobile terminal in step S581. The composed composite photograph is an incomplete one as illustrated in FIG. 8B or 8C, and may take one of the first type as illustrated in FIG. 8B or 8C, the second type as illustrated in FIG. 9A, and the third type as illustrated in FIG. 9B.

If the received composite photograph matches with the composite photograph having been sent in step S573, the control unit 113 combines multiple received composite photographs together into a complete composite photograph in step S583. As described above, a received composite photograph may take various forms. Thereafter, the control unit 113 determines whether a transfer request for the complete composite photograph is issued in step S585. If the transfer request is issued, the control unit 113 sends an MMS message containing the complete composite photograph to the MMSC 200 with a request for delivery of the MMS message containing the complete composite photograph to mobile terminals having participated in composite photographing in step S587.

Next, another description is given of the second composite photographing method using multiple mobile terminals. In FIG. 11, mobile terminals use Bluetooth communication for composite photographing. FIG. 11 is a sequence diagram of the second composite photographing method using mobile terminals based on short-range communication according to an exemplary embodiment of the present invention. In FIG. 11, Bluetooth communication will be used as an example of short-range communication.

Referring to FIG. 11, the first mobile terminal 100a composes an incomplete composite photograph, generates a participant list, sets photo-section information, and activates the Bluetooth module to select mobile terminals as recipients of the composite photograph in step S601. The first mobile terminal 100a sets the photo-section information by assigning photo-sections of the composite photograph to mobile terminals in the participant list. Assignment of a photo-section may be made through a menu or option key available for composite photographing. The first mobile terminal 100a activates the Bluetooth module to select mobile terminals as recipients of the composite photograph.

The first mobile terminal 100a lists obtained remote names of mobile terminals, and selects, for example, the second to n-th mobile terminals 100b to 100n in the participant list based on the obtained remote names in step S603. The first mobile terminal 100a activates the Bluetooth module, discovers Bluetooth-enabled mobile terminals, issues a remote name request to the discovered mobile terminals, obtains remote names from those responding mobile terminals, and displays the obtained remote names. The first mobile terminal 100a uses the obtained remote names to select the second to n-th mobile terminals 100b to 100n in the participant list.

The first mobile terminal 100a performs pairing with the second to n-th mobile terminals 100b to 100n, and establishes a Bluetooth connection to each of them in steps S605 and S607. The first mobile terminal 100a sends the composite photograph, photo-section information, and sender terminal information on the first mobile terminal 100a to the second to n-th mobile terminals 100b to 100n in steps S609 and S611.

Each of the second to n-th mobile terminals 100b to 100n further composes the received composite photograph, and activates the Bluetooth module to transfer the composed composite photograph in steps S613 and S615. For example, the second mobile terminal 100b further composes the received composite photograph by inserting a taken picture into a second photo-section 20 as illustrated in FIG. 8C, and the n-th mobile terminal 100n further composes the received composite photograph by inserting a taken picture into a third photo-section 30 as illustrated in FIG. 8D.

Each of the second to n-th mobile terminals 100b to 100n lists obtained remote names of mobile terminals, and selects the sender mobile terminal 100a in steps S617 and S619. Each of the second to n-th mobile terminals 100b to 100n performs pairing with the first mobile terminal 100a and establishes a Bluetooth connection thereto in steps S621 and S623. Each of the second to n-th mobile terminals 100b to 100n sends the composite photograph to the first mobile terminal 100a in steps S625 and S627.

The first mobile terminal 100a combines the received composite photographs together into a complete composite photograph in step S629. Later, the first mobile terminal 100a can send the complete composite photograph to the second to n-th mobile terminals 100b to 100n having participated in composite photographing.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A composite photographing method using multiple mobile terminals, the method comprising:
composing, by a master mobile terminal, an incomplete composite photograph;
generating, by a master mobile terminal, a participant list of slave mobile terminals;
sending, by the master mobile terminal, the incomplete composite photograph and participant list to a first slave mobile terminal in the participant list;
receiving, by the first slave mobile terminal, the incomplete composite photograph and participant list;
further composing, by the first slave mobile terminal, the received composite photograph;
determining, by the first slave mobile terminal, whether the composed composite photograph is complete;
sending, by the first slave mobile terminal, when the composed composite photograph is incomplete, the composed composite photograph to a second slave mobile terminal in the participant list; and
sending, when the composed composite photograph is complete, by the first slave mobile terminal, the composed composite photograph to all mobile terminals having participated in composite photographing.

2. The method of claim 1, wherein a mobile terminal in a composite shot mode one of composes and further composes a composite photograph by inserting a taken picture into at least one photo-section of the composite photograph.

3. The method of claim 2, wherein the second slave mobile terminal comprises a mobile terminal in the participant list that has not yet participated in composite photographing.

4. The method of claim 2, wherein each of the mobile terminals participating in composite photographing belongs to the participant list.

5. The method of claim 1, wherein transmission of a composite photograph is performed through one of a radio frequency module and a short-range wireless module.

6. A composite photographing method using multiple mobile terminals, the method comprising:
composing, by a master mobile terminal, an incomplete composite photograph;
generating, by the master mobile terminal, a participant list of one or more slave mobile terminals;
setting, by the master mobile terminal, photo-section information for the slave mobile terminals;
sending, by the master mobile terminal, the incomplete composite photograph and photo-section information to slave mobile terminals in the participant list;
receiving, by each of the slave mobile terminals, the incomplete composite photograph and photo-section information;
further composing, by each of the slave mobile terminals, the received composite photograph utilizing the photo-section information;
sending, by each of the slave mobile terminals, the composed composite photograph to the master mobile terminal; and
combining, by the master mobile terminal, the incomplete composite photographs received from the slave mobile terminals together into a complete composite photograph.

7. The method of claim 6, wherein a mobile terminal in a composite shot mode one of composes and further composes a composite photograph by inserting a taken picture into at least one photo-section of the composite photograph based on the photo-section information.

8. The method of claim 7, further comprising sending, by the master mobile terminal, the complete composite photograph to all mobile terminals participating in composite photographing.

9. The method of claim 7, wherein the incomplete composite photographs from the slave mobile terminals to the master mobile terminal are one of a first type composite photograph including both an image selected in composite shot mode and a taken picture, a second type composite photograph including only a taken picture, and a third type composite photograph including a taken picture and associated photo-section indicator in a selected image.

10. The method of claim 9, wherein the incomplete composite photograph from the master mobile terminal to the slave mobile terminals comprises a composite photograph whose photo-section assigned to the master mobile terminal is one of empty and filled with a taken picture.

11. The method of claim 6, wherein transmission of a composite photograph is performed through one of a radio frequency module and a short-range wireless module.

12. A mobile terminal comprising:
an input unit for composing a composite photograph and for generating a participant list;
a communication unit for transmitting a composite photograph and the participant list; and
a control unit for sending a composed incomplete composite photograph and the participant list to a first mobile terminal in the participant list, for further composing, upon reception of an incomplete composite photograph, the received composite photograph, for sending, when the composed composite photograph is incomplete, the composed composite photograph to a second mobile terminal in the participant list, and for sending, when the composed composite photograph is complete, the composed composite photograph to all mobile terminals having participated in composite photographing.

13. The mobile terminal of claim 12, wherein the input unit comprises:
a camera unit for composing a composite photograph in a composite shot mode by taking a picture and inserting the picture into at least one photo-section of the composite photograph; and
a key input unit for generating the participant list.

14. The mobile terminal of claim 13, wherein the second mobile terminal comprises a mobile terminal in the participant list that has not yet participated in composite photographing.

15. The mobile terminal of claim 13, wherein each of the mobile terminals participating in composite photographing belongs to the participant list.

16. The mobile terminal of claim 12, wherein the communication unit comprises one of a radio frequency module and a short-range wireless module.

17. A mobile terminal comprising:
an input unit for composing a composite photograph, for generating a participant list, and for setting photo-section information assigning photo-sections of a composite photograph to different mobile terminals in the participant list;
a communication unit for transmitting a composite photograph and the photo-section information; and
a control unit for sending an incomplete composite photograph and the photo-section information to one or more mobile terminals in the participant list, for further composing, upon reception of an incomplete composite photograph from a first mobile terminal, the received composite photograph, for sending the composed composite photograph to the first mobile terminal, and for combining, upon reception of incomplete composite photographs matching with the incomplete composite photograph having been sent, the received incomplete composite photographs into a complete composite photograph.

18. The mobile terminal of claim 17, wherein the input unit comprises:
a camera unit for composing a composite photograph in a composite shot mode by taking a picture and inserting the picture into at least one photo-section of the composite photograph; and
a key input unit for generating the participant list and for setting the photo-section information.

19. The mobile terminal of claim 18, wherein the control unit sends the complete composite photograph to all mobile terminals participating in composite photographing.

20. The mobile terminal of claim 18, wherein the incomplete composite photograph sent to the first mobile terminal comprises one of a first type composite photograph including both an image selected in composite shot mode and a taken picture, a second type composite photograph including only a taken picture, and a third type composite photograph including a taken picture and associated photo-section indicator in a selected image.

21. The mobile terminal of claim 20, wherein the incomplete composite photograph sent to mobile terminals in the participant list comprises a composite photograph whose photo-section is one of empty and filled with a taken picture.

22. The mobile terminal of claim 17, wherein the communication unit comprises one of a radio frequency module and a short-range wireless module.
